(19) United States
(12) Patent Application Publication
(10) Pub. No.: US 2007/0162339 A1
(43) Pub. Date: Jul. 12, 2007

(54) Method and System for Sending and Processing Messages Received Electronically

(76) Inventors: Andreas Arning, Tuebingen (DE); Matthias Kloppmann, Sindeifingen (DE); Gerhard Pfau, Breitenstein (DE); Dieter Roller, Schoenaich (DE)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/621,214

(22) Filed: Jan. 9, 2007

(30) Foreign Application Priority Data
Jan. 10, 2006 (EP) 0610211.9

(51) Int. Cl. G06Q 30/00

(52) U.S. Cl. 705/14

(57) ABSTRACT

In a computer system of a sender, means is generated for a message. The means represents a reward offer for a receiver of the message for acting on the message. The message and means are sent to at least one receiver. The message and means associated with the message are received in a receiver computer system. It is checked whether the message is acted on in accordance with the reward offer in the receiver computer system. Realization of the reward offer is initiated in response to the message being acted on in accordance with the reward offer.

### FIELD OF THE INVENTION

The present invention relates in general to sending and processing of messages received electronically. The invention may be employed in a collaborative system where different people and machines communicate using an electronic communication system; for example an electronic mail system where people and/or machines exchange information, or for example a workflow management system, where people and/or machines exchange requests for performing certain tasks. More particularly, the invention relates to a computerized method and corresponding means and a computer program product of sending and processing messages received electronically.

### BACKGROUND OF THE INVENTION

A frequent problem in this field is the overwhelming and increasing flood of incoming communication items, for example electronic mail documents. Even worse, the more important a person, the more communication items he or she receives. As a consequence, it becomes harder and harder for the person to process all received requests. For a sender, it becomes harder and harder to get a piece of information through to an important person, even if this would be very desirable for the sender.

This problem gets worse with the growing volume of commercial mail (“spam mail” volume). At the same time it may be somewhat easier to get the same piece of information to a different person who is less flooded with requests.

Over time, certain solutions and best practices have emerged to cope with the increasing flood of communication items in the field of electronic mail systems.

Some email systems use priority markers, for example an “urgent” flag to indicate high priority. The disadvantage of this solution is that these markers only allow a very coarse-grained assignment of priorities (just two or sometimes three different values are usually possible). Furthermore, these markers only reflect the individual perception of the sender about the importance or value of the message, not the perception of the receiver—not to talk about a sender who on purpose “oversells” the importance of his or her message. Furthermore, the perception of different senders and receivers as to what importance or value means is usually not based on an agreed, common understanding. Finally, there is no common understanding of what the urgent flag means. One interpretation is “Important”, in other words “please do not ignore this message”. An alternative interpretation is “Time critical”, in other words “this information needs to be acted on very quickly, to take advantage of the provided information”.

Other email systems provide special support for handling delivery receipts; it is possible for a sender to specify a delivery option enabling the sender to get a receipt as soon as the recipient opens the mail document. The disadvantage of this approach is that this mechanism only signals the sender whether a mail document was opened by the receiver, but it does not allow the sender to take any influence on the fact whether the document will be opened or ignored. Furthermore, quite a number of email systems provide the receiver with the capability to completely disable this mechanism.

Other email systems provide a sender black list. This means that the receiver restricts the incoming requests so certain known malicious senders or groups of senders are disallowed to get requests delivered to the receiver. This list is usually not transparent to potential senders. Disadvantages of sender black lists are that communication from honest potential senders (being accidentally on the black list) is inhibited, often without giving the honest sender the details of whether a request is received, or why it was not received. In addition, less honest senders can artificially vary their identity to avoid matching with the inhibited identities.

The use of sender white list in email systems means that the receiver restricts the incoming requests so only known honest senders or groups of senders are allowed to get requests delivered to the receiver. This list is usually not transparent to potential senders. Disadvantages of this approach are that communication from honest potential senders (being not on the white list) is inhibited. In addition, less honest senders may induce or guess identities that will probably be on the white list (for example, the CEO of the intended receiver's company) and fake the sender identity to match such an entry possibly on the white list.

Using electronic signatures in email systems avoids the risk that less honest senders may fake a sender identity. Some electronic communication systems let the sender add a digital signature, the validity of which can be checked by the receiver, for example by relying on a trusted party that manages private keys (for signing) and public keys (for validating the signature) for each sender. The disadvantage of this mechanism is that it only inhibits the use of faked sender identities, which is responsible only for a small share of the overwhelming and increasing flood of incoming communication items.

In some email systems, spam mail filters open and check all incoming communication items automatically for their content, for example by rating whether the used character strings look rather suspicious or rather like business content. Thus, certain incoming communication items are rated as unwanted and just filtered out. The decision whether an incoming communication item is undesired or welcome may be done by handcrafted rules, or by automatically induced rules derived from training data. The receiver may or may not have influence on the actually used set of rules. The disadvantage in using spam mail filters is that the actual decision, whether an incoming communication item is undesired or welcome, may be hard to predict and even surprising for both sender and receiver. For example, accidental similarity of an honest communication item to a previous, undesired communication item may cause a honest communication item to be discarded accidentally, and therefore this method inherits all problems of censorship. Additionally, less honest senders may make undesired communication items (such as spam mail) look like welcome ones (for example, by adding typical words used in business letters), or suspicious words are intentionally misspelled to bypass the pattern matching.

U.S. patent publication 20040114735 entitled “Handling of Messages in an Electronic Messaging System” discloses a system and method for enhanced visualization of message documents. This system classifies incoming documents by the role the receiver has for each document (the receiver is on a To: list versus the receiver is on cc: list). For different documents where the receiver has the same role, no further distinction is made.

U.S. Pat. No. 5,377,354 describes in detail for mail processing systems how the different mail attributes can be exploited and merged into one priority value, which then can be used by the receiver to establish a processing order for the incoming requests. Like with spam mail filters, the disadvantage of this approach is that the actual decision, whether an incoming communication item is undesired or welcome, may be hard to predict and even surprising for both sender and receiver. Thus the mechanism for assigning priority values is not transparent, and it is not necessarily easy to compare two competing communication items. In addition, the sender has only marginal influence on the resulting priority.

U.S. Pat. No. 5,917,489 describes in detail for mail processing systems how mail receiving users can specify some rules that trigger certain actions on the attributes of an incoming mail document. A disadvantage is that although these rules allow automated pre-selection for the receiver of communication items according to receiver-specific rules, the sender has only marginal or no influence on what will happen to a communication item. In addition, communication items with unanticipated attributes may lead to surprising results.

A best practice in using email systems is “making the subject line informative”. In systems where a short summary of the content (e.g. subject line or abstract) can be transmitted by the sender and will show up in an overview list for the intended receiver, it often pays off to use this short summary to motivate the intended receiver to take a closer look at the content. However, reducing the content to the short version can cause the loss of information and the introduction of ambiguities, which bears the risk that an interesting content looks uninteresting, or that an uninteresting content looks more interesting than it actually is. Also, a sender may willfully “oversell” the content of his message. In addition, it may be the case that the intended receiver receives so many communication items that he cannot even afford to look at the short versions of all items, in which case even a valuable summary will not help the sender to get the communication item to the sender.

A problem still not solved is that a sender of an electronic communication item (for example, an e-mail) has only marginal influence on whether the intended receiver will receive and process this item. Even for a honest sender, the odds for getting a communication item delivered to and processed by a receiver depend on various parameters which cannot be influenced by the sender. Some examples of these parameters are the actual heuristics used in any filters that happen to be installed between sender and receiver; accidental similarity/proximity of the sender's request to already rejected requests (this is applicable, for example, for self-learning spam filters); actual decisions by possibly involved human assistants which pre-filter incoming communication items; current workload (number of requests) for the intended receiver; habits of intended receivers how to select a subset of requests in case more requests are available than can be processed; and auto-delete policies currently implemented (such as purge requests after 90 days).

As a summary, a problem with current solutions for electronic messaging is that the sender has a quite limited influence on whether a receiver will receive and act on an message sent to the receiver.

### SUMMARY OF THE INVENTION

The present invention allows both the sender of an message and the intended receiver of an message to have influence on processing of the message. A first aspect of the invention relates to a computerized method for handling messages received electronically in a computer system of a receiver, the method comprising
receiving an message and means associated with the message, the means representing a reward offer for a receiver acting on the message,
checking whether the message is acted on in accordance with the reward offer in the computer system, and
initiating realization of the reward offer in response to the message being acted on in accordance with the reward offer, unless the reward offer is declined by the receiver.

A second aspect of the invention relates to a computerized method for sending messages received electronically in a computer system, the method comprising
generating means for an message, the means representing a reward offer for a receiver of the message for acting on the message, and
sending the message and means to at least one receiver.

A further aspect of the invention relates to a computer program product comprising a computer useable medium having a computer readable program, wherein the computer readable program when executed on a computer causes the computer to carry out steps in accordance with a method of the first aspect of the invention.

An aspect of the invention relates to a computer program product comprising a computer useable medium having a computer readable program, wherein the computer readable program when executed on a computer causes the computer to carry out steps in accordance with a method of the second aspect of the invention.

An aspect of the invention relates to a computer system for handling messages received electronically, the computer system configured to
receive an message and means associated with the message, the means representing a reward offer for a receiver acting on the message,
check whether the message is acted on in accordance with the reward offer in the computer system, and
initiate realization of the reward offer in response to the message being acted on in accordance with the reward offer, unless realization of the reward offer is defined to be discarded.

A further aspect of the invention relates to a computer system for handling messages received electronically, the computer system configured to
generate means for an message, the means representing a reward offer for a receiver of the message for acting on the message, and
send the message and means to at least one receiver.

Advantages of embodiments of the present invention are to allow negotiating a compromise between a sender and a receiver on how to handle message spontaneously sent by the sender and how to compensate for work the receiver has to do when processing the messages received electronically. Both parties can have influence on the fact whether an message is ignored or not, by allowing a transparent priority measure which is easy to compare, so various messages received electronically can be easily ranked in a transparent way. In addition, this mechanism helps to prioritize messages received electronically using the “supply and demand” principle, so very busy/overloaded people get a higher compensation for processing an message than less busy/overloaded people. In some embodiments of the invention, the reward offer is a monetary reward.

When an embodiment of the invention uses measurable reward offers like monetary offers, the rewards have clear meaning to both the sender and the receiver, and the rewards are comparable between competing senders. This is in contrast to, for example, sophisticated spam filters having a learning component, thus making it hard to predict which messages received electronically will be filtered away. This is also in contrast to approaches where the sender has no control whether the message will reach the receiver because there may or may not be filtering, such as white list filtering or spam filtering, in effect. This is also in contrast to approaches where the receiver has no control on limiting the number of incoming messages received electronically because the receiver has allowed all messages received electronically to come through in order not to miss any possibly important messages. Embodiments of the invention can, however, instead of being used alone, alternatively be combined with known filtering techniques. In this case, embodiments of the invention would help a receiver differentiate between messages received electronically passing filters.

Embodiments of the invention, when applied to an electronic messaging system, allow for the scenario where any sender can send some non-requested advertisement to a very busy person, by attaching fair monetary compensation amount for disturbing this very busy person. A sender thus has a fair chance that the very busy person will take notice of that advertisement).

The foregoing, together with other objects, features, and advantages of this invention can be better appreciated with reference to the following specification, claims and drawings.

### BRIEF DESCRIPTION OF THE DRAWINGS

FIG. 1a shows a flow chart of a method for sending an message in accordance with a first embodiment of the invention;

FIG. 1b shows a flow chart of a method for processing an message in accordance with the first embodiment of the invention;

FIG. 2a shows a flow chart of a method for processing an message in accordance with a second embodiment of the invention relating to a workflow system;

FIG. 2b shows a flow chart of a method for processing an message in accordance with the second embodiment of the invention relating to an electronic mail system;

FIG. 3a shows a flow chart of a method for sending an message in accordance with a third embodiment of the invention employing verification information;

FIG. 3b shows a flow chart of a method for processing an message in accordance with the third embodiment of the invention employing verification information;

FIG. 4 shows schematically a block diagram of a sender and receiver computer system in accordance with an embodiment of the invention; and

FIGS. 5a and 5b show a flow chart of a process of sending and receiving an email according to a detailed embodiment of the current invention.

### DESCRIPTION OF EMBODIMENTS OF THE INVENTION

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In the following description, embodiments of the invention are discussed in more detail. By the way of one example, reference is made to workflow systems, which are information technology systems that help various organizations to specify, execute, monitor, and coordinate the flow of work cases within a distributed office environment. As a second example, reference is made to electronic mail systems. Embodiments of the invention may be applicable also in other computing systems, where parties (for example, persons or computer processes) exchange messages received electronically. Further examples are a communication system processing chat messages, a communication system processing Short Message Service (SMS) messages, and a browser processing pop-up window requests.

Regarding workflow and electronic mail systems, it is possible that embodiments of the invention are implemented by providing an add-on computer program to an existing workflow or electronic mail system. Alternatively, an existing workflow or electronic mail system may be modified to implement an embodiment of the invention. The same is true for any other communication systems arranged to implement an embodiment of the present invention.

Although specific terms may be used in describing embodiments of the invention, the description thus given uses terminology in a generic and descriptive sense only and not for purposes of limitation.

The present invention can be realized in hardware, software, or a combination of hardware and software. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context means any expression, in any language, code or notation, of a set of instructions intended to cause a system having an information processing capability to perform a particular function either directly or after either or both of the following a) conversion to another language, code or notation; b) reproduction in a different material form.

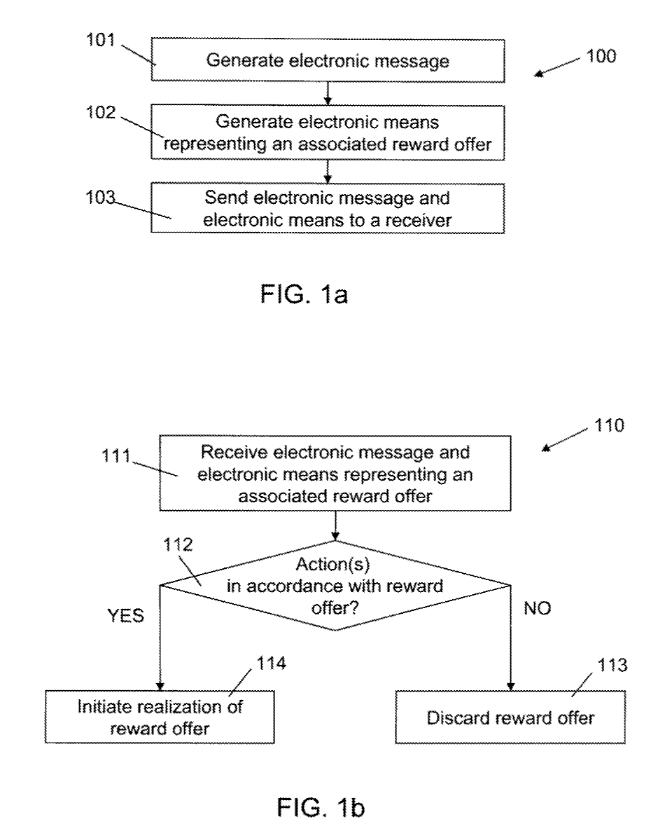

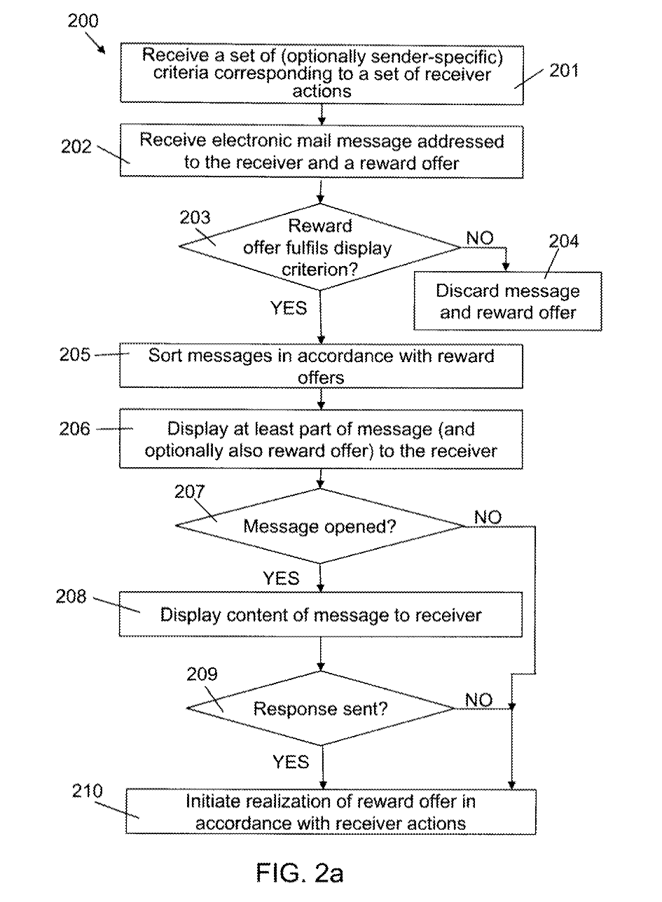

FIGS. 1a and 1b relate to a first embodiment of the invention. In this first embodiment, the sender of an message associates a reward offer with an message. The reward offer is typically a monetary offer, but alternatively or additionally some other resources may be offered to the receiver. For example, a reward may be a right to a certain amount of computing resources. Advantageously the reward is a measurable quantity, so that rewards associated with various messages received electronically can be easily compared to each other.

FIG. 1a shows a flow chart of a method 100 for sending an message in a computer system in accordance with an embodiment of the invention. In step 101, the computer system of the sender generates an message. In step 102, the computer system generates means for the message. The means represents a reward offer for a receiver of the message for acting on the message. The means is thus any electronic data structure capable of representing the reward offer. The precise format of the data structure typically depends on the specific implementation. Step 102 may involve a trusted party of an electronic payment system. The trusted party may actually generate the means in response to a request from the sender.

In step 103, the computer system of the sender sends the message and means to at least one receiver. The means representing the reward offer is typically included in the message, but it may alternatively be delivered to the receiver separately from the message. For example, a sender may inform receivers that a given reward offer applies to all messages received electronically sent by this receiver. If a trusted party of an electronic payment system is involved and it generates the means, the message and means may be sent to the receiver via the trusted party. For example, the sender may send information specifying the message and the reward offer to the trusted party. The trusted party then generates the means accordingly and sends the message and means to the receiver. Similar considerations about the involvement of a trusted party are applicable to other embodiments of the present invention.

It is possible that the reward offer defines a set of actions for the message. In this case, there is typically a specific reward associated with each action. As an example, for an electronic mail message, the one or more of the following actions may be defined in the reward offer: displaying a subject line of the email message, reading the subject line, opening the email message, and responding to the email message. A set of actions and a corresponding set of rewards allow the receiver (of the receiver computer system) to determine, which action or actions are to be performed on the message.

It is alternatively or furthermore possible that the message is sent to a plurality of receivers and that the means represents a set of reward offers intended for the receivers. For example, there may be a separate reward offer for each receiver, or a given reward offer may be applicable to a group of receivers. As further examples, all the receivers acting on the message may receive the reward or only the first receiver requesting realization of the reward offer may be compensated.

It is possible that the reward offer depends on time. For example, the reward offer may decrease as time elapses. A further possibility is that the reward offer will be realized only if the receiver acts on the message within a predefined time period. The reward offer then typically specifies this time period.

FIG. 1b shows a flow chart of a method 110 for processing an message in a receiver computer system in accordance with the first embodiment of the invention. In step 111, the receiver computer system receives an message and associated means representing a reward offer for acting the message. As mentioned above, the means representing the reward offer may be included in the message or delivered separately to the receiver. In step 112, the receiver computer system checks whether one or more actions in accordance with the reward offer have been performed on the message. The action or actions may have been performed with user interaction or without user interaction, depending on the type of the message and/or on the type of the communication system. If user interaction is involved, the receiver computer system is responsive to user actions. If no action defined in the reward offer has been performed, the reward offer is discarded in step 113. If at least one action defined in the reward offer has been carried out, the receiver system initiates realization of the reward offer (in other words, generally initiates payment of a monetary reward) in step 114. Of course, if the receiver is not interested in receiving the reward, the receiver may decline the reward offer even when actions defined in the reward offer have been carried out. Decline of a reward offer may be specified beforehand or, alternatively, the receiver computer system may prompt the user to confirm realization of the reward. To process messages received electronically automatically, information about declining reward offers would be supplied to the receiver computer system for example as a configuration file.

Details of the realization of the reward depend typically on the payment scheme employed for paying the reward. Typically the receiver contacts either the sender or a third party acting for the sender when initiating the realization of the reward offer. For example, if the reward offer is a monetary offer, the means may comprise a link to a web site of a trusted party providing a payment scheme for paying the reward. By contacting the trusted party, the reward can be transferred to an account of the receiver. The account of the receiver may be at a trusted party or at a conventional bank. Some examples of payment schemes, which may be applicable in connection with the present invention, are PayPal, Click&Buy, Web.cent and t-pay. The means may alternatively comprise a token representing digital money. In this case, the realization of the reward refers to processing of the token in accordance with the relevant payment scheme. Typically this includes contacting a trusted third party or contacting the sender, and presenting the token to the third party/sender. A further example of the means is a non-repudiable reward offer digitally signed by the sender, which the receiver may represent to the sender (or to a third party) and request fulfillment of the reward offer.

As discussed above, the sender may define separate rewards for actions carried out by the receiver or the receiver computer system. The receiver, on the other hand, may define reward offer criteria for actions that the receiver computer system should either carry out or prepare automatically. In a second embodiment of the invention, the receiver defines a set of criteria (that is, at least one criterion) for the receiver computer system to act an message in response to a reward offer fulfilling a relevant criterion.

For example, in an electronic mail system, this set of criteria may contain one or more of the following: a first monetary threshold for displaying a subject line of the email message (typically together with the reward offer); a second monetary threshold for displaying the content of the email message (that is, opening the email message); and a third monetary threshold for prompting the user to respond to the email message. Typically subject-lines for all email messages having a reward offer fulfilling the relevant criterion will be shown in the inbox. The user may, however, disable automatic email opening or automatic prompting for response. This can be done, for example, by not defining the respective criteria or by setting very restrictive criteria. In this case, the user may decide on opening/responding case-by-case based on the subject-line of the email message and the relevant reward offer.

It is appreciated that although in the preceding paragraph reference is made to displaying an message or part of an message, the receiver computing system may present the message or part of the message to the user with other means. For example, a speech synthesizer may be used t present the (part of the) message to the user. Also the prompting may be done, for example, by displaying a window on the display screen or by requesting the user to response by a voiced announcement.

As a second example, in a workflow system, this set of criteria may specify for a certain workitem one or more of the following actions: the first monetary threshold for allowing the workitem to show up in the to-do list for a certain person or even in the to-do lists of several eligible persons; a second monetary threshold for committing to complete a certain workitem; and a third monetary threshold for completing the workitem. Typically, these criteria will be combined with some timing information which affects the threshold as well.

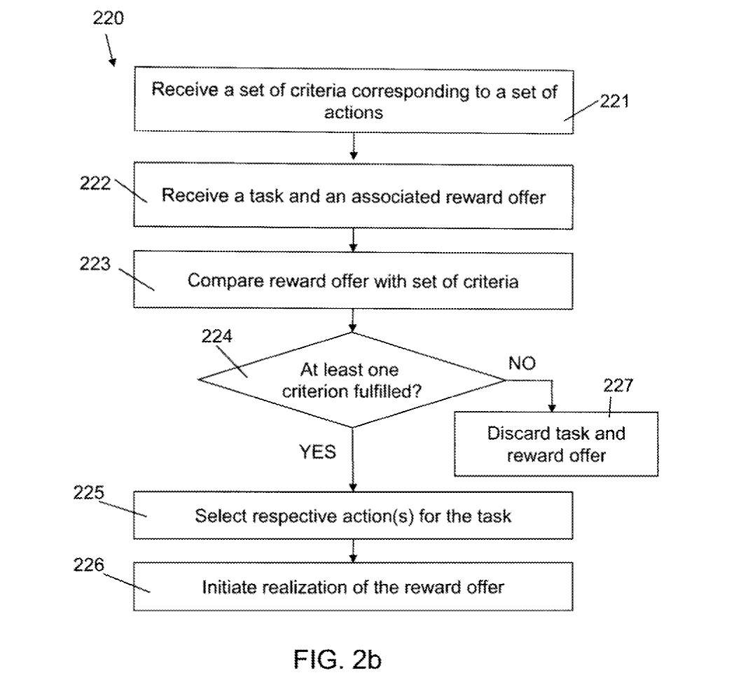

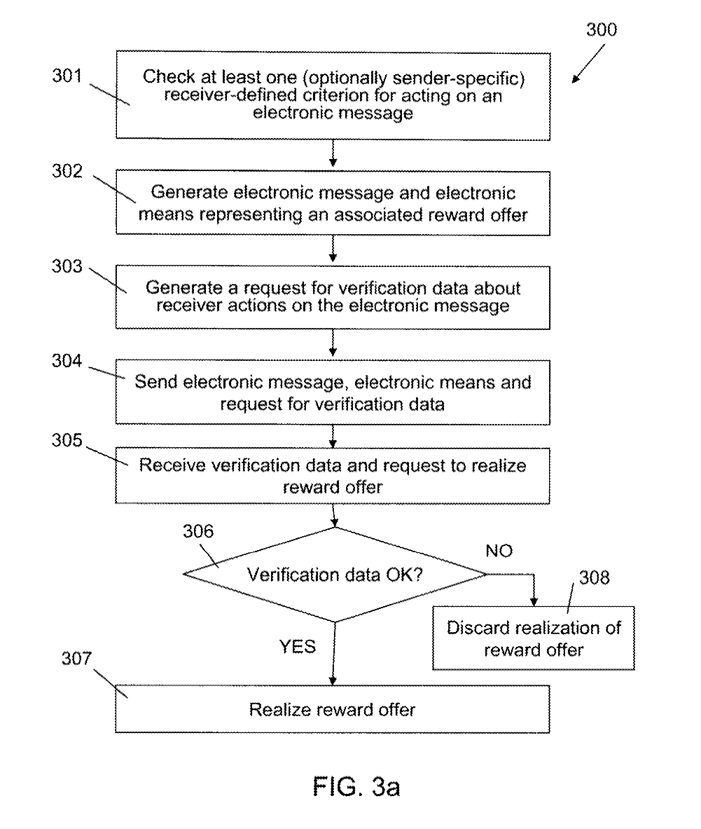

FIG. 2a shows a flow chart of a method 200 for processing an message in accordance with the second embodiment of the invention relating in an electronic mail system. In the electronic mail system, the message comprises an electronic mail message. In step 201, the system receives a set of criteria corresponding to a set of actions from a user (receiver of electronic mail messages) typically via the user interface. Some examples of actions on electronic mail messages are mentioned above. In step 202, the system receives an electronic mail message addressed to the receiver. In step 203, the system checks whether the reward offer associated with the received electronic mail message defines a reward for displaying the subject line which fulfils the possible user-defined criterion. If a criterion for displaying the subject line is not fulfilled, the electronic mail message and the reward offer are discarded in step 204.

In an optional step 205, the messages received electronically may be sorted in accordance with the associated reward offers for display. For example, for displaying subject lines in an inbox, the electronic mail message having the highest reward offer for displaying a subject line is displayed as the first message in the inbox. FIG. 2a relates to this example; at least a part of the message fulfilling the display criterion, typically the subject line and maybe sender information, are displayed to the user in step 206. Typically also the reward offer for opening the message is shown at this point. On the other hand, if the sorting step is used in connection with automatically displaying contents of electronic mail messages, the email message having the highest reward offer for displaying content may be displayed to the user first.

If the user decides not to open an electronic mail message (step 207), the system initiates the realization of the reward offer for displaying the subject line (step 210). If the user decides to open the electronic mail message, the system displays the content of the message to the user in step 208. In step 209, the system checks whether the user responds to the electronic mail message. Depending on the outcome of this check, the system initiates realization of the reward offer for opening the message or for responding to the message (step 210).

A receiver may be rewarded separately for each action performed on an message. Alternatively, the receiver may be rewarded in accordance with the highest reward offer defined for the actions the user performed on the message. Further variations in this regard are also applicable.

It is appreciated that FIG. 2a relates to a situation, where a computer system is responsive to user actions after step 206. As an alternative, it is possible that the computer system check in step 203 which all actions (for example, opening the message and prompting the user to respond to the message) should be performed in accordance with the reward offer. Thereafter the actions are performed on the message, and the computer system initiates realization of the reward offer (step 210).

It is appreciated that the reward offer may be applicable whether the receiver computer system automatically performed actions or whether user interaction was required for the actions. For example, even if the reward offer does not fulfil a criterion for automatically prompting the user to answer, the user should be rewarded for an eventual response. Should the sender wish the user to interact with the message for the reward, verification data on user interaction may be requested. More details on verification are discussed below.

FIG. 2b shows a flow chart of a method 220 for processing an message in accordance with the embodiment of the invention relating in a workflow system. In a workflow system, the actions may correspond to the different types of tasks. For example, for human tasks the actions could be 1) to take notice of a task (allow a task to be displayed on a to-do list), or 2) to claim a task (that is, to commit to complete the task) or 3) to complete the task. Or, for automated tasks, the action could be just a manual recovery (in other words, repair) action in cases of failure.

In step 221, the workflow system receives a set of criteria corresponding to a set of actions. This set of criteria may be provided, for example, in the form of a file by an administrator of the workflow system. In step 222, the workflow system receives a task and a reward offer associated with the task. In step 223, the workflow system compared the received reward offer to the set of criteria. If at least one criterion is fulfilled (step 224), the workflow system selects a respective action (or respective actions) in accordance with the reward offer in step 225 and initiates realization of the reward offer in step 226. If any of the criteria is not fulfilled in step 224, the workflow system discards the task and the reward offer in step 227.

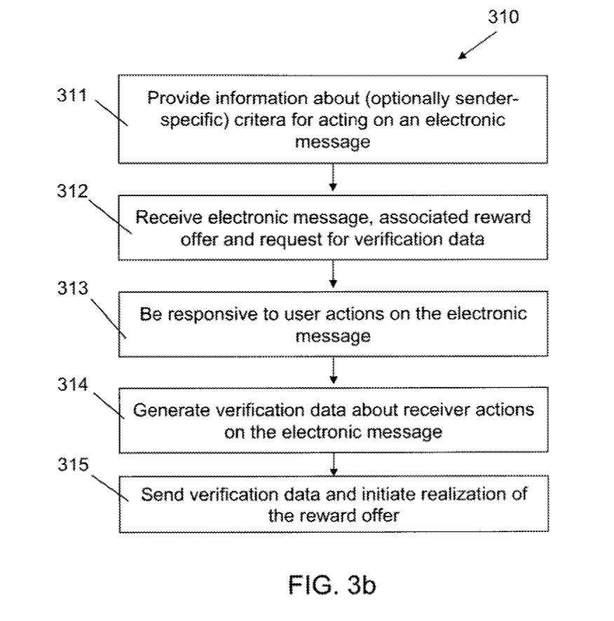

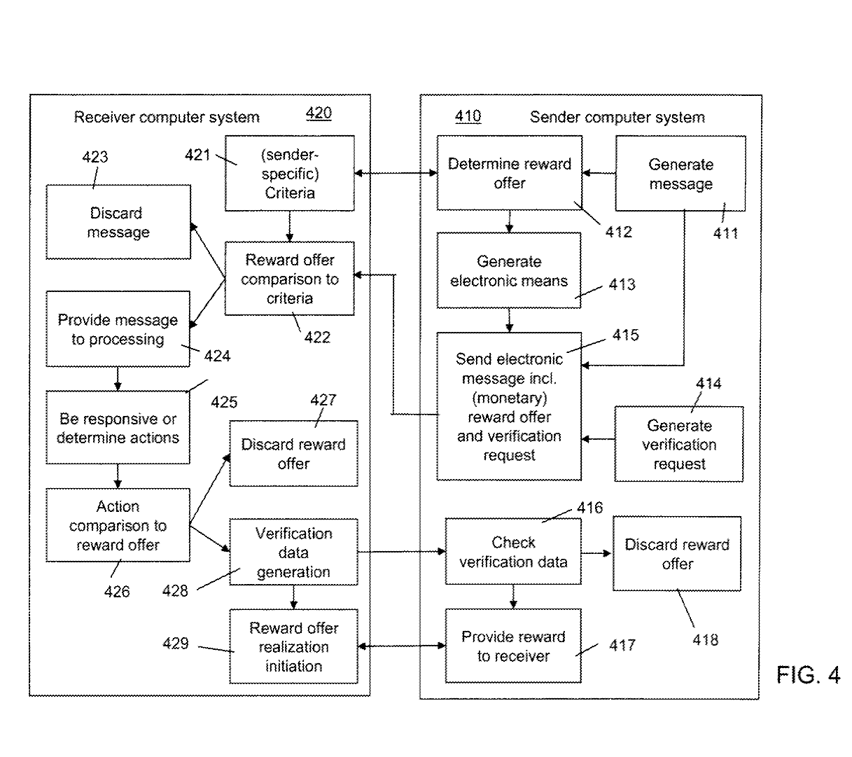

FIGS. 3a and 3b relate to a third embodiment of the invention, where verification data about the receivers actions on the message and sender-specific criteria for reward offers are employed. Although employment of verification data and sender-specific criteria are discussed here in connection with one embodiment, it is clear that either one of these features may be employed without the other.

FIG. 3a shows a flowchart of a method 300 of sending an message and processing verification data in accordance with the third embodiment. A computer system of the sender checks in step 301 at least one receiver-defined criterion for a receiver acting on an message. Information about the receiver-defined criterion may be available, for example, directly from the receivers or from a directory service. As there is typically no sense in sending messages received electronically, where the reward offer is less than a receiver-defined criterion for at least one action on the message, the reward offer is typically determined based on the receiver-defined criterion.

It is appreciated that the receiver-defined criteria for reward offers may be sender-specific. For example, there may be a criterion defined for each possible sender. As a second example of sender-specific criteria, the possible senders may be grouped, and the receiver may define sender-group-specific criteria. If the receiver-defined criteria are sender-specific, the access to the information relating to a specific sender may be restricted only to the respective senders. Access may be protected, for example, authentication or the requestor when requesting a sender-specific criterion. It is also appreciated that a receiver may define a set of criterion corresponding to a set of actions for a sender. Sender-specific criteria allow the receiver to differentiate between the senders. Messages received electronically from a certain sender, for example, may be more welcome than from other senders, and the criterion associated with this sender may be less strict than criteria for other senders.

In steps 302, the sender computer system generates an message and means representing an associated reward offer. In step 303, the sender computer system generates a request for verification data about receiver actions on the message. The request for verification data may be, for example, a verification type code as discussed below in more detail. The aim of requesting verification data is to verify that the receiver has indeed performed those actions on the message for which he wishes to be compensated. In step 304, the sender computer system sends the message, the means and the request for verification data to at least one receiver. The request for verification data is typically included in the message or in the means representing the reward offer.

In step 305, the sender computer system receives verification data and a request for realizing a reward offer from a receiver. In step 306, the verification data is checked and if the verification data confirms that the receiver acted on the message in accordance with the reward offer received in step 305, the reward offer is realized in step 307. The actual details of the realization depend, for example, on the digital cash system employed for the reward. If the verification data is not in accordance with the reward offer realization request in step 306, the realization of the reward offer is discarded in step 308.

Regarding a trusted party of a payment system, the trusted party may generate means representing the reward offer in step 302. The trusted party may also generate the verification request in step 303, for example, if requested by the sender. Also steps 304-307 may be performed by the trusted party.

FIG. 3b shows a flow chart of a method 310 for receiving and processing an message in accordance with the third embodiment of the invention employing verification information. In step 311, the receiver provides information about (optionally sender-specific) receiver-defined criteria for acting on received messages received electronically. As discussed above, a requestor of this information may be authenticated, especially when sender-specific criteria are used. In step 312, the receiver computer system receives an message, means representing an associated reward offer and a request for verification data about receiver actions on the message. In FIG. 3b it is assumed that the reward offer fulfils a (possible sender-specific) criterion, and the receiver acts on the message. The receiver computer system is responsive to the user actions in step 313, and consequently in step 314, verification data about the receiver actions on the message is generated. Some possible verification techniques are discussed in the following with reference, the way of an example, to an electronic mail system.

As a first example, verification data may be based on public key cryptography. Typically some information present in the email message or derivable from the email message would be encrypted using the receiver's private signing key. Information derivable from the email message could be, for example, a hash code calculated based on the content of the email message. In this first example, the verification data provides proof that the email message was processed by an authority that has access to the intended receiver's private signing key. As a second example, verification may provide that the email message was processed using a particular software module. This can be enforced by using signed software modules (techniques as known from the concept of “signed applets”). As a third example, it may be verified that the email message was processed on a particular workstation (or other hardware device) which is known to be associated to the intended receiver. This can be enforced by restricting the reward to be only valid in case the email message was processed on this unique processor with a certain identifier. For this, however, each workstation (or other hardware device) should have a unique identifier that can be considered as public key, and an appropriate private key that cannot be read out of the processor by any means. For example, a smart card can be used for this kind of verification.

As a further example of verification data, it may be verified that a user has indeed opened an email message and read its content. This can be done, for example, by using a method described in U.S. Pat. No. 6,636,241, which is hereby incorporated by reference. As a further example, verification that a human user (rather than a machine) has opened an email message and read its content may be provided. This can be done, for example, by asking the receiver to solve a test which machines are not yet capable to solve. This test can take advantage of human's advanced pattern recognition skills of humans. As an even further example, it may be verified that a particular human user (rather than a proxy human user) has opened an email message personally. For this, the receiver computer system typically needs to include a trusted device (for example, a biometric data reader such as a fingerprint reader or an iris scanner) which guarantees the presence of the intended human at the time a mail was opened (or scrolled, or processed in any other way).

Preferably, the verification should made transparent to the user before the user acts on an email message, to avoid that the receiver acts on the email message but then, for some reason, the receiver computer system is not able to pass the verification. Thus, although FIG. 3b shows steps 313 and 314 as sequential steps, the actions of the receiver and the generation of the verification data may be interleaved or in the opposite order as shown in FIG. 3b.

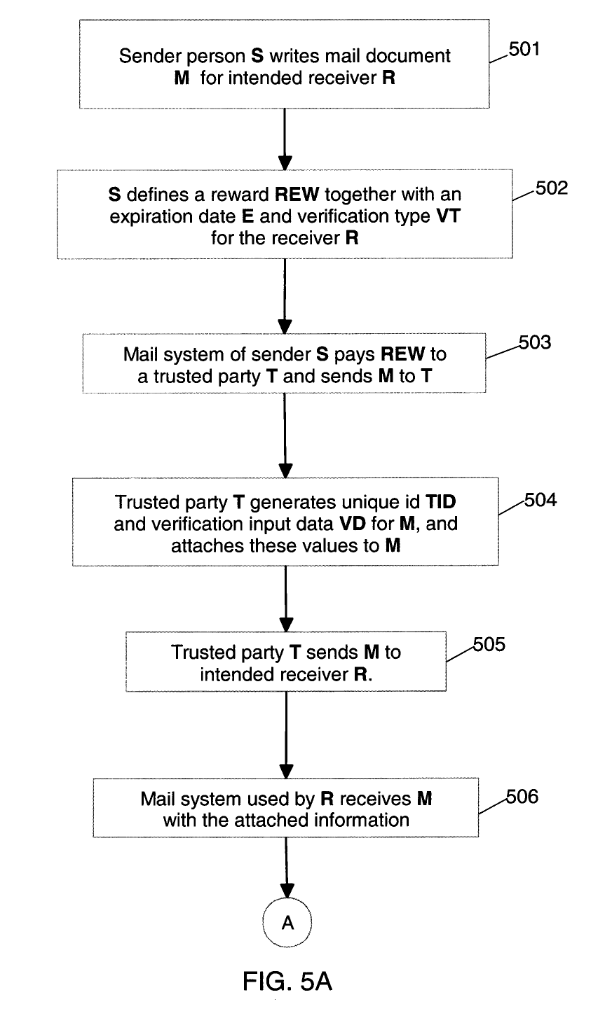

FIG. 4 shows schematically a block diagram of a sender computer system 410 and a receiver computer system 420 in accordance with an embodiment of the invention. In the sender computer system 410, there is a Generate message block 411, where an message is generated based, for example, on user input or on an emerging need for having a task done. In the Determine reward offer block 412, a reward offer associated with the message is determined. The reward offer may be determined based on criteria information obtained from the receiver, either directly or via, for example, a directory service. In the Generate means block 413, an means representing the reward offer is generated. The sender and receiver have typically agreed on a format for the means so that the receiver computer system can easily process the reward offer. If there is need for verification data, a verification request is generated in the Generate verification data block 414. The message, means and (optional) verification request are sent from the Send block 415. Typically the message includes the means and the verification request.

In the receiver computer system 420, a received reward offer may be compared in the Reward offer comparison block 422 to the (optionally sender-specific) criteria defined in the Criteria block 421. Based on the comparison, the received message is either discarded (block 423) or provided to processing (block 424). In the Be responsive or determine actions block 425, the receiver computer system 420 may monitor and be responsive to user actions on the message. Alternatively or additionally, the receiver computer system 420 may determine actions on the received message in response to the reward offer fulfilling predefined criteria. In this case, input is usually needed to the block 425 from the Criteria block 421.

In the Action comparison to reward offer block 426, the actions by the user or by the system are compared to the reward offer. The reward offer is then either discarded (bloc 427) or realization of reward offer is initialized (block 429). If verification data about user actions on the message was requested, the Verification data generation block 428 provides this information.

The sender computer system 410 may have a Check verification data block 416 and a Discard reward offer block 418. If the realization of the reward offer requires involvement of the sender computer system 410, there is a Provide reward to receiver block 417. The Provide reward to receiver block 417 is responsive to the optional Discard reward offer block 418.

Regarding a trusted party of an electronic payment system, blocks 413 to 418 presented in FIG. 4 as part of the sender computer system may be implemented in the trusted party.

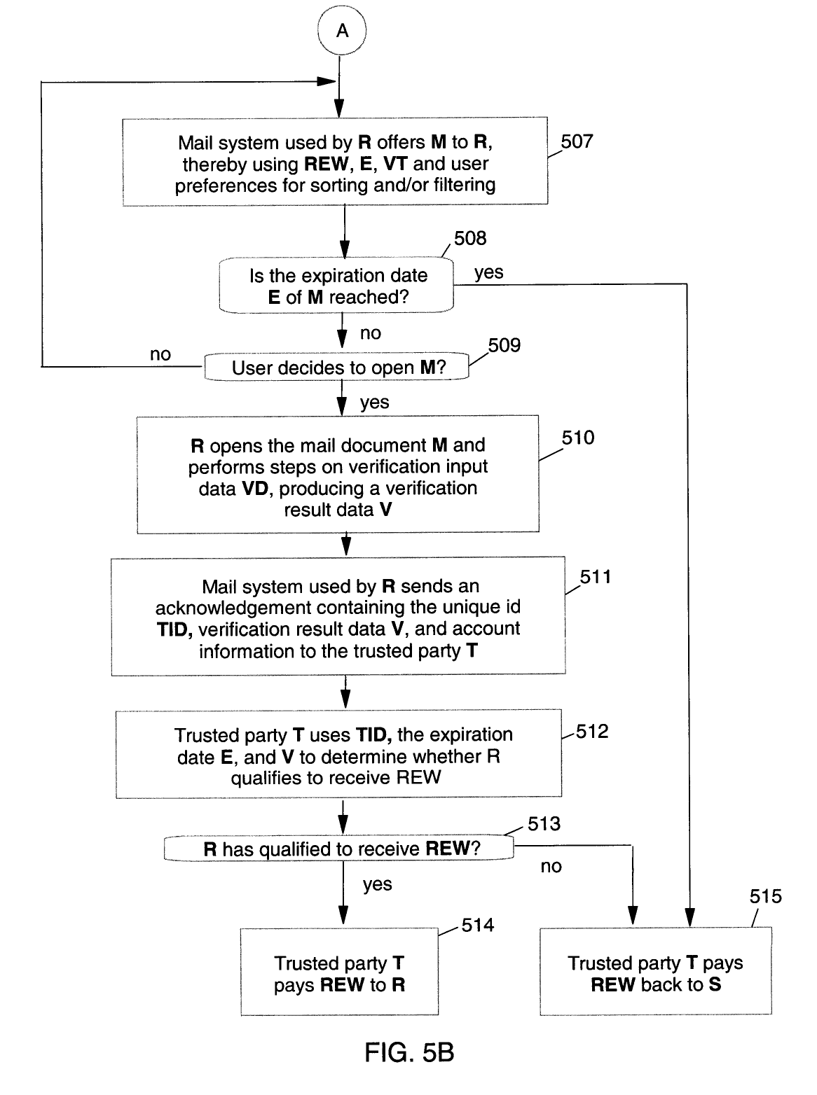

The following detailed description refers to FIG. 5. FIG. 5 shows a flow chart reflecting the sending and receiving of an email according to a detailed embodiment of the present invention.

The detailed embodiment is an extended mail system, extended in that sense that the following behavior is realized. A sender of a mail document can attach a monetary reward to the mail document, which is promised to be paid to the receiver of the mail document for taking notice of that document. The receiver can choose to take notice of the document and receive the offered reward, or ignore the document and loose (i.e. not receive) the offered reward. The receiver has a way to use the characteristics of the attached reward for selection which mail to process first; this can be done by sorting and/or filtering by the amount offered; as well, the amount can be visualized in the overview list of the incoming mails. Preferably, the payment is controlled by a trusted party (for example, micro-payment system) to avoid that the sender promises some reward but later does not follow this promise. Control by a trusted party means that the sender pays the reward (for example, amount of money) to the trusted party at the time the mail is sent. Later, when the reward is to be paid to the receiver, the trusted party handles the payment—or in case that the receiver is not eligible to receive the reward, an unused reward is sent back to the sender. However, when the sender and the receiver trust each other, any other ptotocol without involvement of a trusted party may be used.

The steps performed in a simple version of the preferred embodiment are depicted in FIGS. 5A and 5B. In step 501 the sender person S writes a mail document M for the intended receiver R. Then, in step 502, S additionally defines a reward REW together with an expiration date E and a verification type VT for the receiver R (getting the reward if opening mail document M before its expiration date). In step 503 the mail system of sender S pays the amount REW to a trusted party T and sends M to T. After that in step 504 the trusted party generates a unique identifier TID and verification input data VD for M, and attaches these values to M. The verification input data VD is later on used by the receiver to produce verification results. For example, if the verification type VT requests the pattern recognition task by a human being, the verification input data VD may be a graphical picture, or a noisy audio image for which the human being should respond what picture was recognized. A pattern recognition task could as well be delegated to some trusted external service which offers a pattern and requests that the users responds what was recognized. Then in step 505 the trusted party T sends M to intended receiver R. In step 506 the mail system used by receiver R receives the mail document M with the attached information.

In step 507 the email system used by R offers M to R, thereby using REW, E, VT and user preferences for sorting and/or filtering. In step 508 (FIG. 5b) it is checked, whether the expiration date E of M is reached. If yes, the method continues with step 515, otherwise in step 509 it is checked, whether R decides to open M. If R does not decide to open M, the next step is step 507, otherwise the receiver R opens in step 510 the mail document M. The receiver R performs any necessary steps on the verification input data VD, as specified by the verification type VT, thus producing verification result data V. For example, the verification type may indicate verification by signature, and the receiver signs the verification input data VD with its private signing key, thus providing a signed VD as a verification result data.

In step 511, the mail system used by R prepares an acknowledgement containing at least the unique id TID and the verification result data V. If the reward is paid to an account of the receiver R, information of the account is typically also contained in the acknowledgement. The acknowledgement is sent to the trusted party T. In step 512, the trusted party T uses the identifier TID, the expiration date E (which the trusted party T may have stored in step 504 or receive in step 511) and the verification result data V to determine whether the receiver R qualifies to receive the reward REW (step 513). If the receiver qualifies to receive the reward, the trusted party T pays the reward to the receiver R (for example, to his account) in step 514. Alternatively, the trusted party T pays the reward back to the sender S in step 515.

Preferably, the reward is specified together with an expiration date. Optionally, the reward offered may not be constant over time but may be defined to vary over time; for example, the reward may decrease over time to reward a quick answer higher than a slow answer.

Optionally, the same trusted party taking care of the payment may verify that the intended receiver really takes notice of the sent document before receiving the reward. This may involve one or more of the verification techniques discussed above. Preferably, the use of verifications should made transparent to the user before the user takes notice of a mail document, to avoid that the receiver takes notice of the mail document but then, for some reason, is not able to pass the verification; and only if the verification succeeds, the reward is paid.

Optionally, as discussed above, any potential receiver can make his/her current thresholds (for taking notice of a mail) visible to a potential sender. Different senders may face different thresholds as the mail system of the receiver can add some bonus or malus to each mail before ranking or filtering different mails, depending on the mail's origin (sender, node, domain).

As discussed above, instead of one reward, there may be several rewards attached to one mail document, each one defined for a different operation. For example, the sender may grant a medium reward if the receiver reads the subject line, a bigger reward if the receiver opens the mail and reads it. And, the sender can even grant a small award in case the receiver sends back an automated reply (e.g. “I am out of office”, or “My current threshold for taking notice of a mail is XXX units”).

When a mail document is sent to more than one targeted receivers, the reward specified may be the same for all receivers, or different for different receivers. In the case of more than one receivers, the reward may be paid either only to the first receiver who takes notice of the mail document, or to each receiver who takes notice of the mail document.

In the example specified in the following, it is shown how the method works in the case for unrequested advertisements (that is, for “spam mail”) in the following scenario. The mailing system is assumed to have the following characteristics: sender user-id is not known in advance; format and content of sender's mail not known in advance; and receivers identity visible for all users. A problem in this scenario is that the value of an email for sender and value of an email for receiver may not match. The most prominent example of this value mismatch is spam mail (zero or negative value for receiver, positive value for sender).

To cope with unwanted email messages, embodiments of the invention may be used. The following assumptions are made here. Reward offer units are cents. All rewards cause money flow, managed by the connected micro-payment system. Emails containing reward offers may be processed with emails not containing reward offers (that is, conventional emails) by attaching either real or virtual money to the latter documents as well (for ranking purposes). The attached rewards can be used by the mail program (inbox) for sorting and filtering.

As an example of untargeted high budget advertisement, an email message #1 is sent to million users with the following reward offer: 1 cent for allowing the email to show up in the inbox; 5 cent for opening the email; and 0 cent for sending back an answer. The maximum cost for the sender is $60,000.

As an example of an imprecisely targeted high budget advertisement, an email message #2 is sent to 100,000 users with the following reward offer: 10 cent for allowing the email to show up in the inbox; 50 cent for opening the email; and 0 cent for sending back an answer. The maximum cost for sender is $60,000.

As an example of a precisely targeted low budget advertisement, an email #3 is sent (very selectively) to 10,000 users with the following reward offer: 50 cent for allowing the email to show up in the inbox; 50 cent for opening the email; and 0 cent for sending back an answer. The maximum cost for sender is $10,000.

As an example of a low budget mass mail, an email #4 is sent to million users with the following reward offer: 0 cent for allowing the email to show up in the inbox; 1 cent for opening the email; and 0 cent for sending back an answer. The maximum cost for the sender is $10,000. There may be users that open this type of mail because of the reward.

As an example of a zero budget mass mail, an email #5 is sent to million users with the following reward offer: 0 cent for allowing to the email to show up in the inbox; 0 cent for opening the email; and 0 cent for sending back an answer. There is thus no cost for sender from this reward offer.

As an example, of a regular (low priority) business mail between companies, an email #6 is sent to 20 users with the following reward offer: 50 cent for allowing to the email to show up in the inbox; 50 cent for opening the email; and 500 cent for the first addressee sending an answer. The maximum cost for the sender is 25 Dollars.

As an example of a regular (high priority) business mail, an email #7 is sent to 10 users with the following reward offer: 200 cent for allowing the email to show up in the inbox; 100 cent for opening the email; and 800 cent for the first addressee sending an answer. The maximum cost for the sender is 38 Dollars.

In the following some example filter settings are discussed for highlighting, how different receivers may adjust their filter settings in accordance with the present invention.

A business person, whose role is in the higher management may use the following criteria: criterion for seeing subject line is 100 cent or higher; and criterion for automatically seeing content is 500 cent or higher. Of the above given example emails, this person sees only the regular high priority email (#7) and, if interested, this person may decide to open the mail. However, the email system may offer a possibility to look at other mails above even though they do not fulfil the criterion for seeing subject line.

A business person, whose role is in the first line management, may use the following criteria: criterion for seeing subject line is 10 cent or higher; and criterion for automatically seeing content 50 cent or higher. This person sees emails #2, #3, #6 and #7 of the above examples and will as well be confronted with the content of these emails automatically (for example, in a preview pane).

A private person in a hurry may use the following criteria: criterion for seeing subject line is 50 cent or higher; and criterion for automatically seeing content is 10 cent or higher. This person thus sees emails #3, #6 and #7 of the above examples and will as well be confronted with the content of these emails automatically (for example, in a preview pane).

A private person having some more time may use the following criteria: criterion for seeing subject line is 10 cent or higher; and criterion for automatically seeing content is 10 cent or higher. A private person having much time may use the following criteria: criterion for seeing subject line is 1 cent or higher; and criterion for automatically seeing content is 1 cent or higher.

Embodiments of the invention allow the following mechanisms to take place. A real penalty (in the form of the reward to be paid) may be put on the sender for using high priority. This way it is possible to have a mechanism that is not immediately abused by using highest possible priority by default. The receiver who processes high priority items first is given a real reward. Sophisticated pricing is allowed, including time dependency, to agree on the reward between the involved parties, and to make the reward for processing the messages received electronically as fair as possible for both parties. A potential receiver may publish the current criteria for taking notice of an incoming message or not. The receiver may change these criteria over time. It is possible to offer a reward to several receivers at the same time, with the constraint that only the first receiver who processes the request will receive the reward; here, the reward may be same or different for different receivers.

It will be obvious to those having skill in the art that many changes may be made to the details of the above-described embodiments without departing from the underlying principles of the invention. The scope of the present invention should, therefore, be determined only by the following claims.

We claim:

1. A computerized method for handling messages received electronically in a computer system of a receiver, the method comprising
receiving a message and means associated with the message, the means representing a reward offer for a receiver acting on the message,
checking whether the message is acted on in accordance with the reward offer in the computer system, and
initiating realization of the reward offer in response to the message being acted on in accordance with the reward offer, unless the reward offer is declined by the receiver.

2. A computerized method of claim 1, wherein the reward offer defines a set of actions on the message.

3. A computerized method of claim 2, comprising comparing the reward offer to a criterion set having at least one predefined criterion.

4. A computerized method of claim 3, comprising
determining at least one action of the set of actions in response to the reward offer fulfilling at least one predefined criterion of the criterion set, and
performing the at least one action of the set of actions for the message.

5. A computerized method of claim 4, where the at least one action comprises at least one of the following: presenting at least part of the message and at least part of the reward offer to the receiver; presenting a subject line of the message; presenting content of the message; and prompting a response to the message.

6. A computerized method of claim 3, comprising discarding the message unless the reward offer is fulfilled by at least one predefined criterion of the criterion set.

7. A computerized method of claim 3, comprising presenting at least part of the message to the receiver irrespective of the reward offer being fulfilled by at least one predefined criterion of the criterion set.

8. A computerized method of claim 1, comprising sorting messages received electronically in accordance with associated reward offers for presentation to the receiver.

9. A computerized method of claim 4, where the at least one action comprises at least one of the following: presenting the message in a to-do list; committing to perform a task associated with the message; completing the task; and performing manual recovery in case of failure in completing the task.

10. A computerized method of claim 3, comprising comparing the reward offer to at least one sender-specific predefined criterion.

11. A computerized method of claim 3, comprising providing to possible senders of messages received electronically information on at least one predefined criterion to which the reward offer is compared.

12. A computerized method of claim 1, comprising generating verification data about receiver actions on the message.

13. A computerized method of claim 12, wherein the verification data relates to at least one of the following: biometric data of a person acting on the message; the receiver's private signing key; a unique identifier of the computer system of the receiver; and information providing proof that a person has read the message.

14. A computerized method of claim 1, wherein the message comprises at least one of the following: an email message, a chat message, a Short Message Service message, a request for opening a pop-up window in a browser, and a task of a workflow system.

15. A computerized method for sending messages electronically in a computer system, the method comprising
generating means for a message, the means representing a reward offer for a receiver of the message for acting on the message, and
sending the message and means to at least one receiver.

16. A computerized method of claim 15, wherein the reward offer defines a set of actions on the message.

17. A computerized method of claim 15, wherein the means represents a set of reward offers corresponding to a set of receivers.

18. A computerized method of claim 15, comprising requesting verification data about receiver actions on the message.

19. A computerized method of claim 15, comprising
checking at least one receiver-defined criterion for acting on an message before generating the means, and
determining the reward offer based on the at least one receiver-defined criterion.

20. A computerized method of claim 15, wherein the message comprises one of the following: an email message, a Short Message Service message, a chat message, a request for opening a pop-up window in a browser, and a task of a workflow system.

21. A computer program product comprising a computer useable medium having a computer readable program, wherein the computer readable program when executed on a computer causes the computer to:
receive a message and means associated with the message, the means representing a reward offer for a receiver acting on the message,
check whether the message is acted on in accordance with the reward offer in the computer, and
initiate realization of the reward offer in response to the message being acted on in accordance with the reward offer.

22. A computer program product comprising a computer useable medium having a computer readable program, wherein the computer readable program when executed on a computer causes the computer to:
generate means for a message, the means representing a reward offer for a receiver of the message for acting on the message, and
send the message and means to at least one receiver.

23. A computer system for handling messages received electronically, the computer system configured to
receive a message and means associated with the message, the means representing a reward offer for a receiver acting on the message,
check whether the message is acted on in accordance with the reward offer in the computer system, and
initiate realization of the reward offer in response to the message being acted on in accordance with the reward offer.

24. A computer system of claim 23, wherein the computer system forms at least one of the following: an email system, a browser system processing pop-up window requests, a Short Message Service system, a chat message system, and a workflow system.
